(19) United States
(12) Patent Application Publication
(10) Pub. No.: US 2012/0132089 A1
(43) Pub. Date: May 31, 2012

(54) Round Baler

(76) Inventor: Jeremy Pourchet, Chargey-les-Greay (FR)

(21) Appl. No.: 13/117,801

(22) Filed: May 27, 2011

(30) Foreign Application Priority Data
Jun. 1, 2010 (EP) EP 10164608.1

(51) Int. Cl. A01F 15/07; A01F 15/08

(52) U.S. Cl. 100/88; 100/76

(57) ABSTRACT

A round baler has a bale chamber that is partly covered by a gate, which is journaled in a frame via a gate bearing which is coaxial to a roll bearing of a roll. The gate bearing has a radial slot to release the roll and/or the roll bearing.

### FIELD OF THE INVENTION

This invention relates to a round baler having a frame and a gate with at least one roll, wherein the gate and the roll are connected to the frame; by way of a gate bearing and a roll bearing arranged concentrically to one another.

### BACKGROUND OF THE INVENTION

German Patent Document DE 31 18 663 A1 discloses a round baler with a gate, which is vertically pivotally connected to a front frame. The pivot axis of the gate bearing coincides with an axis of an upper front roll of the gate which carries a belt.

In such designs it is necessary to remove the gate in order to in order to replace the upper front roll. This is a labor intensive and cumbersome process which in some cases requires a lifting device such as a crane.

Accordingly there is a need in the art for an improved roll mounting arrangement wherein the roll can be removed and replaced without removing the gate.

### SUMMARY OF THE INVENTION

The gate according to the invention may assume any structure, for example with or without sidewalls, with rolls only or with belts or chains trained over rolls, etc. The gate is journaled in a frame via a gate bearing which, is coaxial to a roll bearing of a roll. The gate bearing has a radial, slot to release the roll and/or the roll bearing. The gate and/or roll bearing may be of the thrust, ball, roller, tapered roller, spherical or needle type and these bearings may follow onto each other in the axial or in the radial direction. The slot needs to be wide enough to let pass at least an axle or a stub shaft at the axially outer end areas of the roll. The meaning of the term “slot” covers any kind of opening of the bearing in the radial direction. This solution permits removal of the roll without removing the gate and thus is faster and does not require a lifting device such as a crane or the like.

In order to securely hold the gate on the frame, but at the same time allow removal of the roll through the slot, a removable bridge is provided over the gate bearing, which can be fixed by way of bolts, clamps etc. The bridge is preferably formed as a semicircle and can be provided in varying sizes.

A simple way to fix and remove the roll bearing is by fixing it at the face side of the gate bearing, which is easily accessible and does not require tight tolerances at the radially inner and outer surface. The roll bearing may be provided with apertures or protrusions to be fixed, or contained in a cavity or within a shoulder on the gate bearing. Alternatively it may be fixed on the frame.

The removal of the roll is facilitated if the slot of the gate bearing extends through the surrounding part of the gate, such that a radial movement is possible. Alternatively, a large opening can be provided in the bearing area, through which the roll can be removed in an axial direction.

In order to strengthen the gate in the slot area and to prevent crop accumulation in the slot, the slot can be closed by a plate or another structural part serving the same: purpose as a plate. The plate is preferably bolted to the surrounding gate area.

It should be noted that gates without stiff sidewalls and haying instead skirts overlapping side walls on the main frame in the closed position, are lighter than conventional gates and create less stress: in the area of the split gate bearing.

Similarly, gates which do not define the bale chamber with rolls (fixed chamber balers), but instead employ endless belts (variable chamber balers) are lighter and hence create less stress. In addition, if the belt spans the entire distance between the sides of the bale chamber no crop can exit and be exposed to the rotating shaft of the roll, thus protecting the bearings from crop debris.

A closed or substantially closed surface, i.e. one through which only small particles such as dust or the like can escape also prevents the escape of larger crop particles, that may affect the. bearings. In order to avoid collapse of the belt, its side edges are routed on or in paths. The paths may be formed in or on the sidewalls, the skirts etc.

### BRIEF DESCRIPTION OF THE DRAWINGS

The embodiments of the invention will be described in detail below with reference to the accompanying drawings wherein:

FIG. 1 is a side view of a round baler;

FIG. 2 is a perspective view of a gate of the round baler of FIG. 1 with a wide belt carried on a path on both sides and with a gate lock;

FIG. 3 is a perspective view of a right hand part of the gate of FIG. 2 in a raised position and in contact with a side wall of a bale chamber;

FIG. 4 a sectional view along the line 4-4 of FIG. 3;

FIG. 5a depicts a condition wherein the gate is closed;

FIG. 5b depicts a condition wherein the gate is slightly opened;

FIG. 6 is an enlarged view of a gate lock and a counter lock; arid,

FIG. 7 is an exploded view of the gate bearing.

### DESCRIPTION OF THE PREFERRED EMBODIMENT

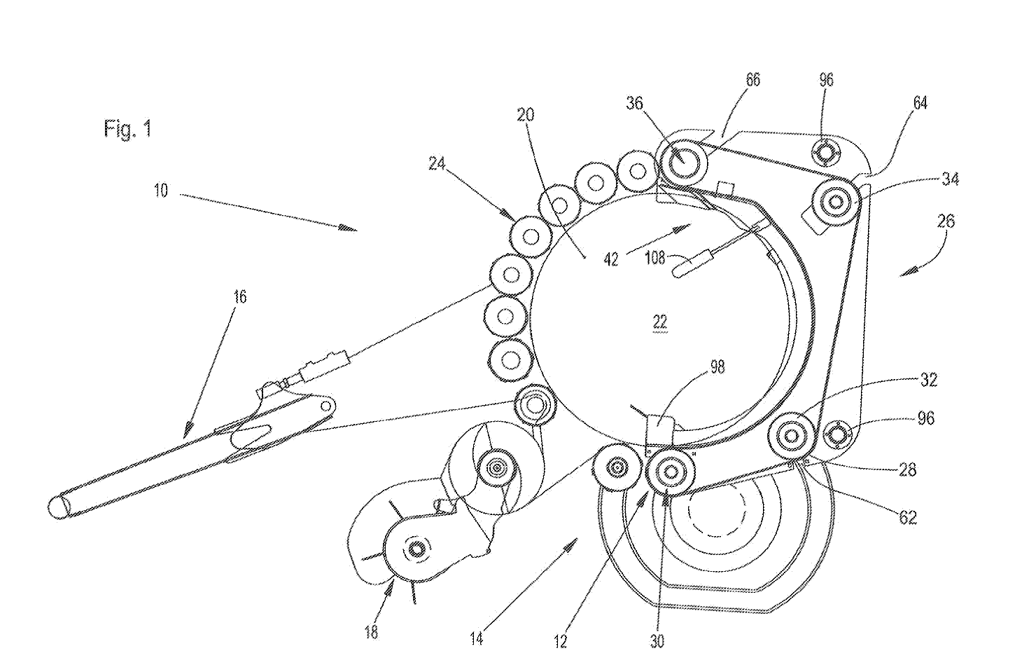

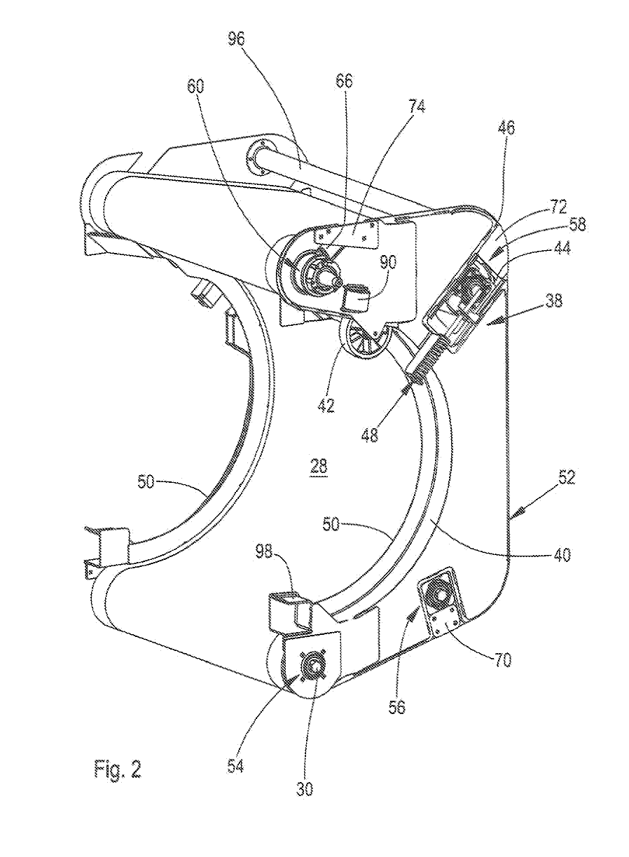

FIG. 1 shows a round baler 10 having a frame 12, a chassis 14, a tongue 16, a feeder 18 and a bale chamber 20.

The round baler 10, as shown, is of the fixed chamber type, i.e., the bale chamber 20 is of fixed size in the front and of fixed or substantially fixed size in the rear; it could be also of a variable chamber type in the front. While the round baler 10 is mobile, it could also be stationary for use in industry. In normal operation the baler is moved over a field to bale harvested crop like straw, hay, grass, cotton or the like, whereas in industry it may bale paper, garbage, etc.

The frame 12 is of a welded and bolted structure, which is not shown in detail here, but is well known in the art, like from JOHN DEERE round balers, and is supported on the chassis 14. Part of the frame 12 is defined by side walls 22, extending vertically and apart from one another in a horizontal direction. These side walls 22 may be of one part along the length of the bale chamber 20 or of two parts, being split and hinged to each other substantially vertically—both types being well known in the art. The side walls 22 are big enough to cover the bale chamber 20 laterally. The cuter and free periphery of the side walls 22 (see FIG. 4) substantially follow a circle, which does not exceed the diameter of a complete bale; it might also be smaller than the diameter of the bale. As can also be seen in FIG. 4, the front part of the side walls 22 is hinged, whereas the rear part is free. This free movement away from the bale reduces the friction on the bale, once a gate 26 is raised, yet it seals the bale chamber 20 laterally to the extent possible.

The chassis 14 comprises an axle, wheels, suspension and the like, as are necessary to support the frame 12 moveably on the ground.

The tongue 16 connects the round baler 10 to a pulling vehicle and is fixed to the frame 12 or the chassis 14.

The feeder 18 may comprise a pick-up and/or a cutting rotor and/or a cross auger. The latter are not necessary for a round baler, but are often used. The feeder 18 is carried by the frame 12, is variable in height to adjust to the ground contour and feeds material normally lying on the ground rearward into the bale chamber 20.

The bale chamber 20 is surrounded by bale forming elements 24 in the front and the gate 26 in the rear.

The bale forming elements 24 in the front are formed as a series of stationary rolls arranged substantially on a semi circle as this is widely known. These rolls are driven in a conventional manner and thus not described further.

The gate 26 in the rear mainly contains a single endless, closed surface and flexible belt 28, i.e. spanning the entire bale chamber 20 and being of a material known from current round balers on the market Such a belt 28 has several layers of fibers, in the lengthwise and crosswise direction and is covered on both sides with rubber or the like having a smooth or profiled surface; The belt 28 is made endless by connecting existing ends or by producing it as a single piece. Additionally, and as will become apparent from the further description the belt 28 has a different function in its center area as compared to its lateral end areas, since in the inner or center area it is in contact with the material to be baled and to be moved by the belt 28, whereas in the lateral end areas the belt 28 has to glide in or on a path 40. Accordingly it may be of different types in its regions, like of a kind creating more friction in the center area compared to the outer areas. Internal crosswise extending fibers (not shown) will be of such strength, that they hinder the belt 28 from collapsing into the bale chamber 20 in its upper section. A similar effect may be achieved by fibers being arranged in different layers with respect to the press material contact surface of the belt 28, which fibers are connected to each other to provide additional stiffness, like a flat bar extending radially with respect to the centerline of a bale in the bale chamber 20. Other fibers will extend in the lengthwise direction of the belt 28. The gate 26 is raised by a gate cylinder 108 as is well known. As an alternative to the belt 28, rolls, chains with slats, small belts, etc. may be used.

The belt 28 is routed over a lower front roll 30, a lower rear roll 32, an upper rear roll 34 and an upper front roll 36. The lower front and rear rolls 30 and 32 are journaled freely in the side structures 52 and act as idler rolls, although either of the rolls 30, 32 could be driven to assist in moving the belt 28 with the bale. The upper rear roll 34 is journaled moveably against the force of a tensioning mechanism 38, but is also idling only. The, upper front roll 36 is driven and rubber covered to create enough friction to move the belt 28. All or some or one of the rolls 30-36 may have a barrel shape/which assists in keeping the belt 28 in the center. Furthermore the path 40 is provided in the form of a sheet of metal, bar, rail or the like connected to the side structures 52. The path 40 follows the shape of the bale chamber 20 for the completed bale, i.e. fully or partly circular. The part creating the path 40 is connected to the side structure 52 by means of angles, blocks or the like by bolting, welding or the like. The belt 28 overlaps the path 40 and thus can glide on it without a gap. The surface of the path 40 is provided with or covered by low friction material, like Teflon. The belt 28 moves upwardly inside the bale chamber 20 and downwardly outside of it. It could also be, of the opposite, whereas the function of the rolls 30 and 36 needs to be adjusted. All rolls 30, 32, 34, 36 are oriented parallel to one another.

Also provided is an idler 42 between the downstream end of the path 40 and the upper front roll 36 to guide the inner run of the belt 28. The idler 42 is located such, that it deflects the belt 28 away from the edge of the path 40 to reduce the friction of the belt 28 onto the end edge, of the path 40.

The tensioning mechanism 38 has a plate 44 on each side, each being slideably received in a cavity 46 in the side structure 52. The plates 44 carry the roll 34 and are applied by a spring assembly 48. The spring assembly 48 has a spring and a plain bearing against the plate 44, which results in a movement of the plate 44 in the cavity 46 such, that the belt 28 is tensioned.

Attached at a small distance from the outer surface of the side structure 52 and abutting the path 40 is an inner strip like wall or skirt 50, which like the side walls 22 actually delimits the bale chamber 20 laterally. The skirt 50 is fastened to either the side structure 52 or to the path 40 by appropriate means, like bolts, welding, etc. The radially outer edge of these skirts 50 follows the circular contour of the bale chamber 20 and provides a shoulder on which the belt 28 will rest and glide. The radially inner edge of the skirt 50 follows a circle concentric to the bale chamber 20 or bale, whereas the radial extension may be up to 10 or 15 cm or more or less. This radial extension provides for an overlap between the side walls 22 and the skirts 50, when the gate 26 is dosed. This overlap will assist in sealing the bale chamber 20 against crop to be baled exiting the bale chamber 20. The skirt 50 extends parallel to the side walls 22 and supports the latter against an outward movement due to the pressure inside the bale chamber 20.

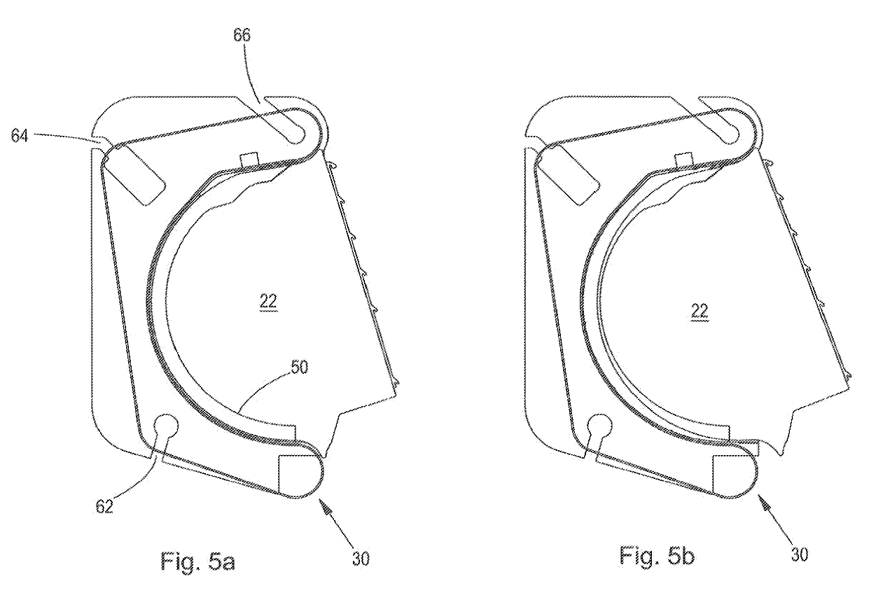

Reference is made to FIG. 5a, which shows the gate 26 in the closed position. In this situation the side walls 22 are located concentrically in the section of the bale chamber 20 in the gate 26 and the lower roll 30 is close to the lower rear edge of the side wall 22. In FIG. 5b due to the pressure in the bale chamber 20 the gate 26 raised slightly and the lower roll 30 moved away from side wall 22. In this situation the side walls 22 are no longer concentric in the gate 26, but there is still an overlap between the skirts 50 and the side walls 22 sealing the bale chamber 20. Depending on the chosen overlap, bales of different diameter may be produced.

The tensioning mechanism 38 may be provided in the space between the skirt 50 and the outer surface of the side structures 52. The idler 42 is also arranged between the skirt 50 and the outer surface, whereas the idler 42 extends beyond the outer surface of the path 40 to touch the belt 28 tangentially.

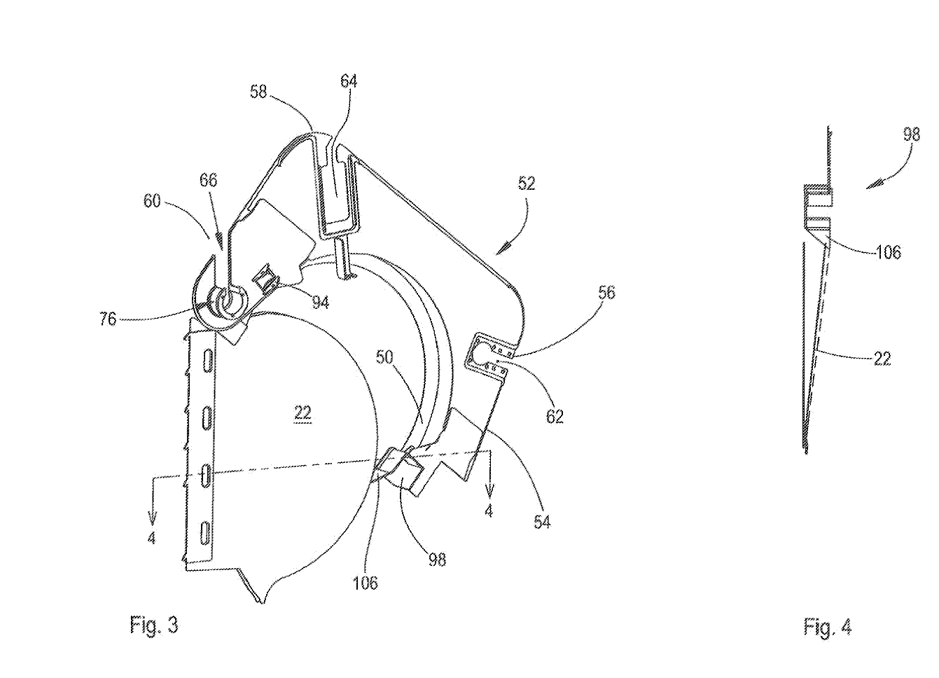

The side structures 52 are formed of strong welded sheet metals and are substantially a mirror image of one another. Both side structures assume substantially the shape of an U, when seen from the side, and extend with their longitudinal plane vertically. The side structures 52 form the side of the gate 26. As can be seen mainly in FIG. 3, the side structures 52 have in the corner zones a lower front bearing area 54, a lower rear bearing area 56, an upper rear bearing area 58 and an upper front bearing area 60.

The lower front bearing area 54 is substantially a square cutout with a flange to receive a bearing (not shown) of the lower front roll 30, as is widely known.

The lower rear bearing area 56 has a slot 62, which extends lengthwise substantially perpendicular to the lower edge of the side structure 52 and also has a flange to receive a bearing for the lower rear roll 32. The slot 62 opens to the periphery of the side structure 52.

The upper rear-bearing area 58 also has a slot 64, which extends lengthwise substantially under an angle of 45 degrees with respect to the adjacent peripheral line of the side structure 52, when it is closed. This slot 64 extends through and in the same direction as the cavity 46 and opens to the periphery of the side structure 52. The bearing of the upper rear roll 34 is not fixed to a flange in this bearing area 58 but to the plate 44 moving along this slot 64 under the control of the tensioning mechanism 38.

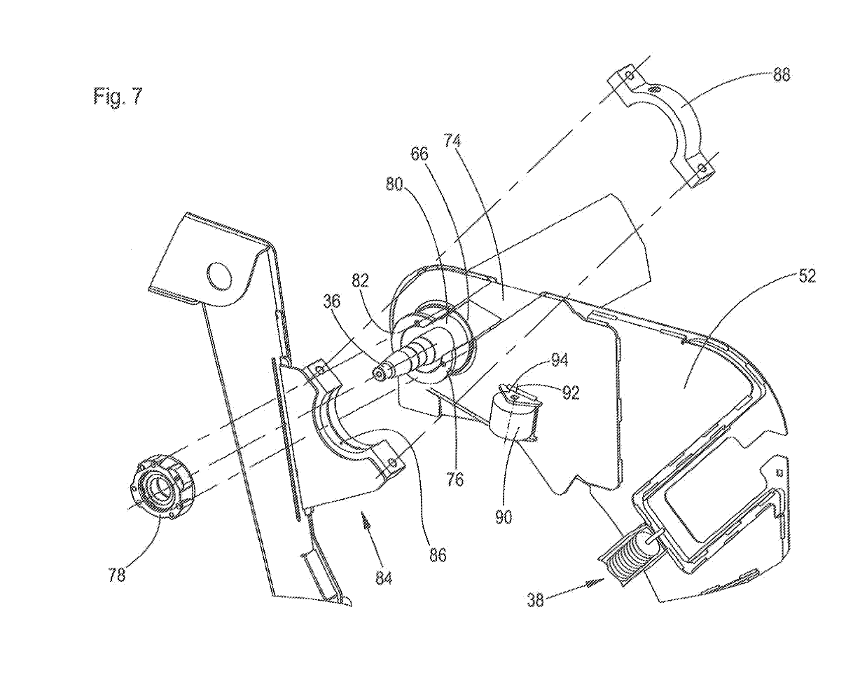

The upper front bearing area 60 again has a slot 66, which extends parallel to the slot 64 and has about the same length. The slot 66 receives a bearing assembly 68, which is described in more detail with respect to FIG. 7. Flanges, i.e. areas with holes to receive bolts, are provided in the side structures 52 sidewards of the slots 62, 64, 66.

The slot 62 can be closed by a plate 70, the slot 64 by a plate 72, and the slot 66 by a plate 74 in order to provide for more stability and to avoid sharp edges, whereas these plates 70, 72, 74 are connected to the respective flanges.

The bearing assembly 68 comprises a gate bearing 76 of the thrust bearing type and a roll bearing 78 of the roller bearing type.

The gate bearing 76 is welded or otherwise rigidly fixed to the upper front bearing area 60, extends through the slot 66 and outwardly of the side structure 52. In this case the gate 26 pivots about an axis in its upper front area, rather than about an axis substantially at the center of the bale. The gate bearing 76 also has a slot 80, which is aligned to the slot 66 in dimensioned direction. A flange 82 is provided on a surface of the gate bearing 76 facing outwardly, in order to receive the roll bearing 78. The gate bearing 76 is journaled in a bearing housing 84. The bearing housing 84 comprises a bearing support 86 fixed to the frame 12 in its upper rear area and a bridge 88, both covering a bearing cavity by 180 degrees each. The bridge 88 is bolted onto the bearing support 86 such that the bearing cavity is open in the same direction as the extension of the slot 66, when the bridge 88 is dismounted. As can be seen in FIG. 7, once plate 74, bridge 88 and roll bearing 78 are dismounted, the roll 36 can be removed radially through the slots 66 and 80.

Between the bearing assembly 68 and the idler 42 a roll 90 is provided. The roll 90 rotates about an axis 92 formed on a holder 94 at the outer surface of the side structure 52. The side structure 52 leaves an opening at the holder 94, such, that the roll 90 may protrude through the side structure 52 until the path 40, i.e. the plane, Where the belt 28 moves. The axis 92 is oriented perpendicular to the path 40 and belt 28 may touch roll 90 with its side edge during its movement in order to provide for guidance.

Between the side structures 52 at least one brace 96 is provided, which extends parallel to either of the rolls 30 to 36 and provides stability to the entire gate 26. The brace 96 may be bolted or welded to the side structures 52.

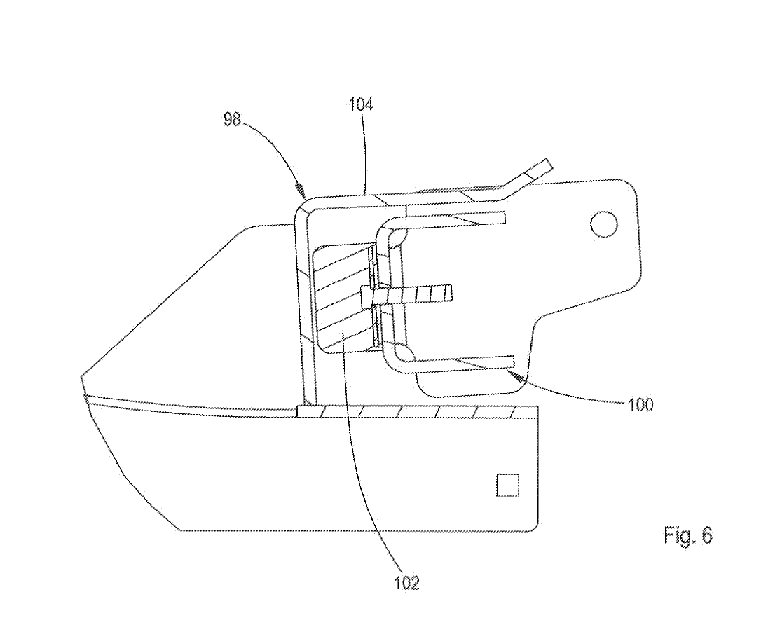

Above the lower front bearing area 54 a gate lock 98 is provided, which has the shape of a cube being open at two adjacent sides, whereas the open sides are at the front and the outside. The gate lock 98 is of sheet metal or cast and rigidly connected to the side structure 52. A counter lock 100 (see FIG. 6) is provided at the frame 12 such, that it may be received in the gate lock 98, when the gate 26 is closed. Between the vertical surfaces of the gate lock 98 and the counter lock 100 facing each other is provided (bolted, glued, etc.) a rubber block 102 to dampen shocks during the movement of the gate 26. A front edge of an upper wall 104 of the gate lock 98 is bent upwardly to assure a smooth mating movement, even, if the side structures 52 would have lowered somewhat. Attached to the upper wall 104 is a horizontal wedge shaped guide 106 (when the gate 26 is closed), whereas a tip of the guide 106 extends outside the side walls 22 and a slanted surface of the guide 106 starting at the tip is oriented such, that the side wall 22 leaning outwards is pushed inwards, when the gate 26 closes, such that it may slide along the inner surface of the skirt 50.

The roll 30 is located such, that it is either in front of or at least below the center of gravity of a bale formed in the bale chamber 20. As a consequence, the bale will rest on the roll 30, when the gate 26 is opened, and due to the gate movement will be moved out of the bale chamber 20. The gate lock 98 and counter lock 100 assist in carrying the weight of the bale.

The roll 32 and tensioning mechanism 38 are aligned to each other such, that the tension in the belt 28 is not strong enough to carry the entire bale weight; partially the bale will be supported by roll 32, which pushes onto the outer surface of the bale, each time the bale rests on the roll 32, which increases its compaction in the circumferential surface.

It is apparent from the above description, that the round baler 10 and the gate 26 are of a mirror image design, with side structures 52, side walls 22, etc. on both sides.

Having described the preferred embodiment, it will become apparent that various modifications can be made without departing from the scope of the invention as defined in the accompanying claims.

The invention claimed is:

1. A round baler having a frame and a gate with at least one roll, the gate and the roll being connected to the frame by way of a gate bearing and a roll bearing arranged concentrically to one another, wherein the gate bearing has a radially extending slot to allow the passage of at least one of the roll bearing and an end portion of the roll.

2. A round baler according to claim 1, wherein the gate bearing is closed by way of a bridge.

3. A round baler according to claim 1, wherein the roll bearing is connected to a front radial surface of the gate bearing.

4. A round baler according to claim 1, wherein the gate comprises a slot extending to its outer contour to allow removal of the roll.

5. A round baler according to claim 1 wherein the slot is closed by a plate.

6. A round baler according to claim 1, wherein the gate comprises side structures with skirts sideward of the bale chamber and stationary side walls, are provided on the frame, the side walls and the skirts being arranged in an overlapping relationship when the gate is closed.

7. A round baler according to claim T, wherein the gate comprises several rolls, over which an endless belt is routed, the endless belt spanning the width of the bale chamber.

8. A round baler according to claim 1, wherein the belt has one of a closed and substantially closed surface and slides one of on and in paths on the gate.
